(19) United States
(12) Patent Application Publication
(10) Pub. No.: US 2011/0291773 A1
(43) Pub. Date: Dec. 1, 2011

(54) Dual-response stopband filter

(76) Inventors: Dominique Lo Hine Tong, Rennes (FR); Jean-Yves Le Naour, Pace (FR); Ali Louzir, Rennes (FR); Raafat Lababidi, Tripoli (LB)

(21) Appl. No.: 12/800,423

(22) Filed: May 14, 2010

(30) Foreign Application Priority Data
May 14, 2009 (FR) 0953204

(51) Int. Cl. H01P 1/203

(52) U.S. Cl. 333/205

(57) ABSTRACT

The invention relates to a dual-response stopband filter as well as to a filtering device comprising such a filter. The dual-response stopband filter comprises between the input terminal and the filter output a first direct channel and a second channel, known as a secondary channel, coupled with the first channel and forming a resonant element. The filter further comprises, integrated on the first direct channel, a selective low-pass filter to reject a first selected frequency band and, integrated on the second channel a variable capacitor to form the stopband filter of a second frequency band that can be determined. The switching device is associated with the first channel to switch the low-pass filter and the second channel to switch the stopband filter.

### FIELD OF THE INVENTION

The invention relates to a dual-response stopband filter as well as to a filtering device comprising such a filter. The invention applies to transmission systems complying with the DVB-H (Digital Video Broadcasting-Handheld) or DVB-T (Digital Video Broadcasting-Terrestrial) standards.

### BACKGROUND OF THE INVENTION

The context of this invention is that of multi-mode and multi-standard terminal design.

In fact the “digital dividend” that represents the frequency resources liberated by the passage of television broadcasting from the analog mode to the digital mode, will certainly be used to enable certain communications.

The liberated frequency bands as well as the dedicated uses are variable from one region to another and even inside a region from one country to another. In terms of use, these bands will be dedicated to the broadcasting of both mobile digital television and telecommunications applications

These liberated frequency bands are particularly sought after by telecommunications operators, due to a superior level of efficiency with respect to frequencies higher than 1 GHz, in terms of coverage and penetration of buildings, and in terms of very much lower costs for the creation and operation of networks.

Thus due to this new situation, the conception of a multi-standard terminal integrating a digital television DVB (Digital Video Broadcasting) receiver must confront the increased problem of the coexistence and the multiplicity of uses of liberated bands.

In fact, the DVB receiver must now not only protect itself from GSM (Global System for Mobile communications), WCDMA (Wideband Code Division Multiple Access), etc. mobile telephone transmissions but also against transmissions from telecommunications systems of for example WiMAX (Worldwide Interoperability for Microwave Access) type.

To better illustrate the problem and using FIG. 1, consider the case of Region 1: In the 790 to 862 MHz band are found channels dedicated to mobile TV and IMT (International Mobile Telecommunication) telecommunications, the channels can be interlaced, and in a neighbouring band, from 880 MHz, are found the cellular telephone bands.

In addition, the assignment of channels for such or such use would vary greatly from one Region to another, and even from one country to another. For Region 2, the channels dedicated to mobile TV and to telecommunications (IMT) are located in the band 698 to 806 MHz while in Region 3, they are located in the band 698 to 862 MHz.

At the same time for Region 2, the channels dedicated to mobile telephony (GSM, WCDMA, etc.) are located in the band 824 to 894 MHz while in Region 3, they are located in the band 880 to 960 MHz and also in the band 824 to 894 MHz.

Faced with these regulations, an appropriate filtering solution capable of adapting to each of the regulations confronted is required.

One purpose of the invention is therefore to protect the mobile television channels from interfering transmissions coming from both telecommunications systems (WiMAX for example) and mobile telephony systems via an appropriate filtering.

Another objective is to reject variable frequency bands of telecommunications and fixed bands from cellular telephony.

In FIG. 2, a diagram is shown representing the potentially usable frequency bands for WIMAX systems for region 1. Three variable telecommunications frequency bands (B1-B3) to be rejected as well as the frequency band above for example of 862 MHz are shown.

Such a topology of a first stopband filter is proposed by Guyette et al. (“Exact Synthesis of Microwave Filters with Non-uniform Dissipation”, IEEE IMS-2007).

This filter, as shown in FIG. 3, comprises a direct channel between the input terminal and the output terminal of the filter to which is coupled a secondary channel forming a resonant element.

At the resonance frequency and at the output of the filter, the signals from the direct transmission line and the resonant element will be combined in phase opposition, creating as a result a theoretically infinite attenuation in a relatively very narrow band around the resonance frequency.

A synthesis method enables account to be taken of the factor of quality of the resonant element and a hyper-selectivity of the filter to be guaranteed. This is obtained by the addition of an attenuator onto the direct channel with as a consequence an increase in insertion losses outside of the rejected band. Hereafter in this description, it is considered that the constituent elements of the filter are perfect and that the attenuator is no longer required.

According to a standard approach, to this filter rejecting the telecommunications bands, is cascaded another filter rejecting the cellular band.

But this solution is cumbersome, inflexible, and creates relatively high insertion losses that are incompatible with correct DVB H/T reception.

### SUMMARY OF THE INVENTION

The invention consists in a dual-response stopband filter comprising between the input terminal and the filter output a first direct channel and a second channel, known as a secondary channel, coupled with the first channel and forming a resonant element.

The filter comprises a selective low-pass filter to reject a first selected frequency band, integrated onto the first direct channel, and

a variable capacitor to form a stopband filter of a second frequency band that can be determined, integrated onto the second channel.

The invention also consists in a filtering device comprising a dual-response stopband filter and a switching device associated with the first channel and second channel to switch the low-pass filter and to switch the stopband filter.

Preferentially the switching device is formed by a first diode D1 placed in series or in parallel with the variable capacitor and a second diode D2 placed in parallel with the low-pass filter.

The filter or the filtering device comprising 2 filters, one fitted in the other, thus has the advantage of reducing at the same time the total size and the insertion losses.

Another advantage resides in this topology comprising a dual response, for which one can be variable without interfering with the other significantly.

The switching device associated with this new filter enables the response to be adapted to requirements, according to interfering elements encountered and the regulations of each Region or country.

### BRIEF DESCRIPTION OF THE DRAWINGS

Figures

The characteristics and advantages of the aforementioned invention will emerge more clearly upon reading the following description made with reference to the drawings attached in the appendix, wherein:

FIG. 1, already described, shows a diagram of frequency bands allocated and potentially usable for WiMAX systems according to three different regions,

FIG. 2, already described, shows an example of frequency bands potentially usable for WIMAX systems,

FIG. 3, already described, shows the structure of a stopband filter as is known in the art,

FIG. 4 shows the structure of a filter according to the invention,

FIG. 5 shows the graph of the frequency response of a filter according to the invention,

FIG. 6 shows a filtering device according to the invention.

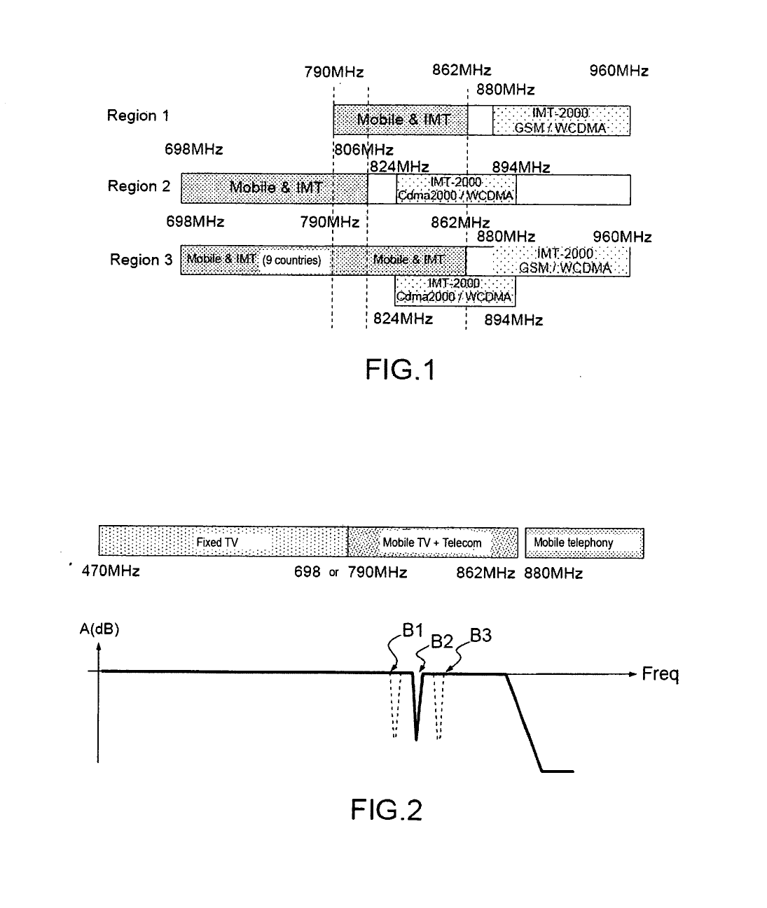

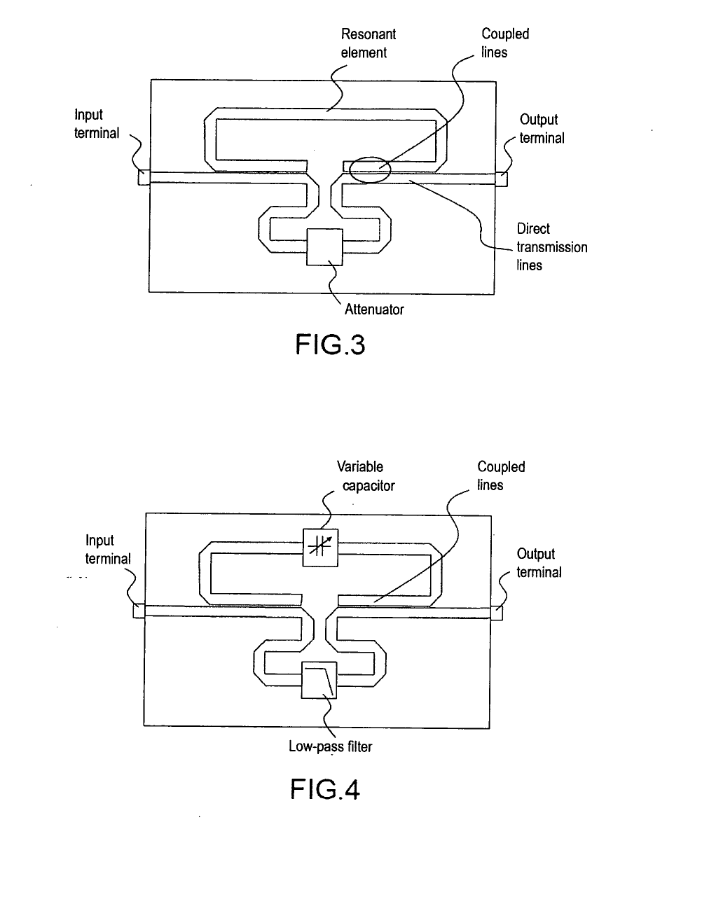

### DETAILED DESCRIPTION OF PREFERRED EMBODIMENTS

The invention relates to a filter structure dedicated to a fixed and mobile digital television receiver complying for example with the DVB-H/T standards. The filter has a dual response, in the sense that it combines both a stopband (notch) type response enabling telecommunications signals transmitted in the digital dividend band to be rejected and a low-pass response enabling mobile telephone signals to be rejected. The proposed structure results from the integration of a low-pass filter into a stopband filter, and not from a simple cascading of two filters.

Moreover, the stopband filter can be frequency tuned so as to dynamically reject telecommunications signals whatever their positions in the digital dividend band, thus adapting themselves to the geographical zone where the terminal is being used.

From the basic structure of the stopband filter proposed by the document cited corresponding to the “Guyette et al” prior art, the invention shown in FIG. 4 proposes a filter with a dual-response and for which the stopband part can be frequency tuned.

This filter thus comprises, on the direct channel between the output terminal and the input terminal, a selective low-pass filter that allows all the frequency bands of the fixed and mobile TV broadcast to pass and rejects those of mobile telephony (GSM, etc.).

Typically, with reference to FIG. 2, this low-pass filter will have a cut-off frequency at 862 MHz. This frequency being distant from the resonant frequency of the stopband filter, the low-pass filter does not interfere with its operation.

On the secondary channel coupled to the direct channel and comprising the resonant element, a variable capacitor is inserted and enables the resonant frequency of the stopband filter to be obtained in the telecom/WiMAX channel for which the transmissions risk saturating the TV receiver.

FIG. 5 shows the dual-response obtained with a stopband filter created in the bandwidth of a selective low-pass filter. A variable band B of telecommunications frequencies is rejected at the rejection frequency of the stopband filter as well as the frequency band rejected by the low-pass filter above for example at 862 MHz.

A switching system enables the performances of the filter according to the invention to be optimised, for example for a TV receiver, according to possible interfering elements. This switching system also enables the device to adapt to very varied requirements according to the regulations of the Regions and countries.

The switching system comprises 2 diodes inserted in the filter such that a diode D1 is placed in series with the variable capacitor and a diode D2 is placed in parallel with the low-pass filter.

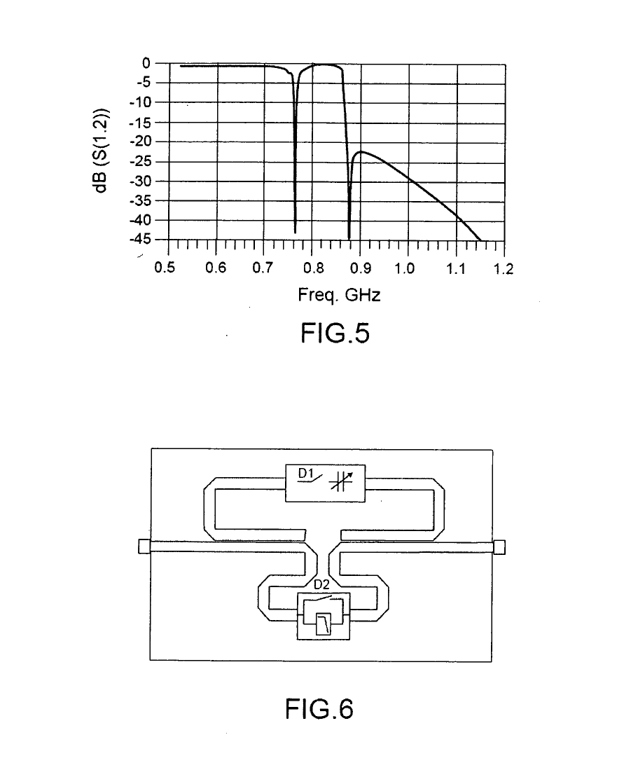

The filtering device comprising the filter described previously and intrinsically this switching device is shown in FIG. 6. It enables the following scenarios to be confronted:
In the complete absence of an interfering element, the diode D1 is open circuit (CO) and the diode D2 short-circuit (CC). The filter is thus inhibited and the insertion losses are reduced to a minimum, or to losses of the diode.
In the presence of interfering elements of telecom type only, for example of WiMAX type, the diode D1 is short circuit (CC) and the diode D2 open circuit (CO). The response of the filter is only of the stopband type, with a resonant frequency placed in the WiMAX channel. In this case the losses at the top of the response spectrum are also reduced.
In the presence of interfering elements of mobile telephony type only (GSM, etc), the 2 diodes are open circuit (CO) and the response of the filter is only of low-pass type.
Finally, in the presence of 2 types of interfering elements, telecom and mobile telephony for example, the diode D1 is short circuit (CC) and the diode D2 is open circuit (CO). The dual-response filter presented in FIG. 4 is thus obtained.

A variant of this switching system consists in placing the diode D1 in parallel and not in series with the variable capacitor in which case, in the absence of interfering elements corresponding to it, the diode is short circuit, whereas it is open circuit in the presence of interfering elements.

What is claimed is:

1. Dual-response stopband filter comprising between the input terminal and the filter output a first direct channel and a second channel, known as a secondary channel, coupled with the first channel and forming a resonant element,
wherein the filter comprises
integrated on the first direct channel, a selective low-pass filter to reject a selected first frequency band, and
integrated on the second channel, a variable capacitor to form a stopband filter of a second frequency band that can be determined.

2. Filtering device comprising a filter according to claim 1,
wherein
it comprises a switching device associated with the first channel to switch the low-pass filter and with the second channel to switch the stopband filter.

3. Filtering device according to claim 2,
wherein
the switching device is formed by a first diode D1 placed in series or in parallel with the variable capacitor and a second diode D2 placed in parallel with the low-pass filter.
